(19) United States
(12) Patent Application Publication
(10) Pub. No.: US 2014/0241264 A1
(43) Pub. Date: Aug. 28, 2014

(54) SIGNALING METHOD FOR HANDLING OF DESYNCHRONIZED DEFAULT BEARER CONTEXT OF THE LAST REMAINING PDN CONNECTION

(71) Applicant: Alcatel-Lucent USA Inc., Murray Hill, NJ (US)

(72) Inventor: Jennifer LIU, Plano, TX (US)

(73) Assignee: Alcatel-Lucent USA Inc., Murray Hill, NJ (US)

(21) Appl. No.: 13/960,334

(22) Filed: Aug. 6, 2013

Related U.S. Application Data
(60) Provisional application No. 61/767,970, filed on Feb. 22, 2013.

(51) Int. Cl. H04W 76/06

(52) U.S. Cl. CPC H04W 76/06
USPC 370/329

(57) ABSTRACT

In one example embodiment, a method includes receiving, by at least one user device, a request to deactivate at least one packet data network (PDN) connection between the at least one user device and at least one control node of a communication system. The method further includes determining, by the at least one user device, whether the at least one PDN connection is the only remaining PDN connection associated with the at least one user device and generating, by the at least one user device, a message based on the determining.

### CROSS REFERENCE TO RELATED APPLICATIONS

This non-provisional U.S. patent application claims priority under 35 U.S.C. §119(e) to provisional U.S. patent application No. 61/767,970, filed on Feb. 22, 2013, the entire contents of which are incorporated herein by reference.

### BACKGROUND

Packet data services are provided by packet data networks (PDNs). The operator may provide access to different PDNs with different packet data services. For example, one such PDN may be the public internet. Other PDNs may be specific IP networks to provide operator specific services like Instant Messaging Services (IMS). For a User Equipment (UE)/User Device to access a PDN, a PDN connection needs to be setup. A PDN connection is an association between a UE and a PDN.

In GPRS networks, the PDN connection is realized using Packet Data Protocol (PDP) context. In GPRS networks, mobile devices attach to the network first before requesting any PDP context. These are achieved via separate attach procedure and PDP context activation procedure. Therefore, it is possible that a mobile device may have attached to the GPRS network but with no PDP context established. In GPRS networks, PDP context deactivation may be from mobile device to the network, or from the network to the mobile device, and the request is always accepted because the UE does not have to maintain a default PDP context.

4G Long Term Evolution (LTE) networks are optimized for packet data services. Evolved Packet Core (EPC) is the enhanced packet core that supports establishment and maintenance of data sessions used by mobile devices for packet data services. In a 4G EPC network, the PDN connection is realized using Evolved Packet System (EPS) bearer.

In a 4G EPC network, in order to have “always-on” packet data connectivity, a mobile device should maintain at least one PDN connection at all times. If the last PDN connection is disconnected, the network will detach the mobile device and thus packet data connectivity to the network is lost. Disconnecting the last PDN should only be performed when the UE does not require packet data services any longer.

### SUMMARY

In several instances, there are no signaling methods for handling requests for disconnecting/modifying the last remaining PDN connection in the 4G EPC network.

Accordingly, some example embodiments provide signaling methods for handling requests for disconnecting/modifying data connections associated with the last remaining PDN connection at a UE and/or network control elements. Furthermore, some example embodiments provide signaling methods for handling errors related to information in requests for disconnecting/modifying data connections.

In one example embodiment, a method includes receiving, by at least one user device, a request to deactivate at least one packet data network (PDN) connection between the at least one user device and at least one control node of a communication system. The method further includes determining, by the at least one user device, whether the at least one PDN connection is the only remaining PDN connection associated with the at least one user device and generating, by the at least one user device, a message based on the determining.

In yet another example embodiment, the at least one control node is at least one of a mobile management entity (MME) generating the request and a packet data network gateway (PDN-GW).

In yet another example embodiment, the at least one user device is a 4G Long Term Evolution (LTE) based device.

In yet another example embodiment, the determining further includes analyzing the received request to determine a specific bearer context of the at least one PDN connection indicated in the request and determining whether the specific bearer context corresponds to a default bearer context of the only remaining PDN connection at the at least one user device.

In yet another example embodiment, the generating generates a message indicating a denial of the request if the determining determines that the specific bearer context corresponds to the default bearer context of the only remaining PDN connection at the at least one user device.

In yet another example embodiment, the method further includes transmitting the generated message to the at least one control node.

In yet another example embodiment, the at least one control node aborts the deactivation if the generated message is not received at the at least one control node within a time period set by the at least one control node.

In yet another example embodiment, the method further includes receiving a detach request from the at least one control node and initiating a re-attachment procedure based on the received detach request. The method further includes transmitting a confirmation message regarding the re-attachment procedure to the at least one control node.

In one example embodiment, a method includes receiving, by at least one user device, a first request to deactivate at least one packet data network (PDN) connection between the at least one user device and at least one control node of a communication system and analyzing the received first request. The method further includes generating, by the at least one user device, at least one of an acceptance message and a rejection message based on the analyzing and transmitting, by the at least one user device, the generated message to the at least one control node.

In one example embodiment, the at least one control node is at least one of a mobile management entity (MME) generating the first request and a packet data network gateway (PDN-GW) generating the first request and the at least one user device is a 4G Long Term Evolution (LTE) based device.

In yet another example embodiment, the analyzing includes decoding the received first request, determining whether the first request contains an error corresponding to a mandatory information element of the first request.

In yet another example embodiment, the generating generates a message indicating a rejection of the request if the determining determines that the information element of the first request contains the error

In yet another example embodiment, the method further includes transmitting the message to the MME, wherein the message includes at least one of an invalid mandatory information message and an invalid evolved packet service (EPS) bearer identity message.

In yet another example embodiment, the method further includes receiving a second request, with a corrected mandatory information element, to deactivate the at least one PDN connection.

In yet another example embodiment, the MME aborts the deactivation upon receiving the invalid EPS bearer identity message.

In one example embodiment, a method includes receiving, at a control node of a communication system, a resource modification request from at least one user device of the communication system. The method further includes determining whether the resource modification request is associated with the only remaining packet data network (PDN) connection at the control node and generating a response based on the determining.

In yet another example embodiment, upon determining that the resource modification request is associated with the only remaining PDN connection at the control node, the determining includes analyzing the resource modification request to determine whether a default bearer context of the only remaining PDN connection is to be modified.

In yet another example embodiment, the generating generates a response indicating a denial of the resource modification request if the analyzing determines that the default bearer context of the only remaining PDN connection is to be modified.

In yet another example embodiment, the method includes transmitting the response to the at least one user device.

In one example embodiment, a user device includes a processor configured to receive a request to deactivate at least one packet data network (PDN) connection between the user device and at least one control node of a communication system. The processor is further configured to determine whether the at least one PDN connection is the only remaining PDN connection associated with the user device and generate a message based on the determination.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limiting of the present disclosure, and wherein:

FIG. 1 illustrates a PDN connection, according to an example embodiment;

FIGS. 2A-B illustrate de-synchronization of PDN connections between a user device and a network control node, according to an example embodiment;

FIG. 3 describes a signaling method for handling of default PDN connections at a user device, according to an example embodiment;

FIG. 4 describes a signaling method for handling of default PDN connections, according to an example embodiment; and

FIG. 5 illustrates a signaling method for handling of errors in deactivation requests received at a user device, according to an example embodiment.

### DETAILED DESCRIPTION OF EXAMPLE EMBODIMENTS

Various embodiments will now be described more fully with reference to the accompanying drawings. Like elements on the drawings are labeled by like reference numerals.

Detailed illustrative embodiments are disclosed herein. However, specific structural and functional details disclosed herein are merely representative for purposes of describing example embodiments. This invention may, however, be embodied in many alternate forms and should not be construed as limited to only the embodiments set forth herein.

Accordingly, while example embodiments are capable of various modifications and alternative forms, the embodiments are shown by way of example in the drawings and will be described herein in detail. It should be understood, however, that there is no intent to limit example embodiments to the particular forms disclosed. On the contrary, example embodiments are to cover all modifications, equivalents, and alternatives falling within the scope of this disclosure. Like numbers refer to like elements throughout the description of the figures.

Although the terms first, second, etc. may be used herein to describe various elements, these elements should not be limited by these terms. These terms are only used to distinguish one element from another. For example, a first element could be termed a second element, and similarly, a second element could be termed a first element, without departing from the scope of this disclosure. As used herein, the term “and/or,” includes any and all combinations of one or more of the associated listed items.

When an element is referred to as being “connected,’ or “coupled,” to another element, it can be directly connected or coupled to the other element or intervening elements may be present. By contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting. As used herein, the singular foul's “a”, “an”, and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Specific details are provided in the following description to provide a thorough understanding of example embodiments. However, it will be understood by one of ordinary skill in the art that example embodiments may be practiced without these specific details. For example, systems may be shown in block diagrams so as not to obscure the example embodiments in unnecessary detail. In other instances, well-known processes, structures and techniques may be shown without unnecessary detail in order to avoid obscuring example embodiments.

In the following description, illustrative embodiments will be described with reference to acts and symbolic representations of operations (e.g., in the form of flow charts, flow diagrams, data flow diagrams, structure diagrams, block diagrams, etc.) that may be implemented as program modules or functional processes include routines, programs, objects, components, data structures, etc., that perform particular tasks or implement particular abstract data types and may be implemented using existing hardware at existing network elements. Such existing hardware may include one or more Central Processing Units (CPUs), digital signal processors (DSPs), application-specific-integrated-circuits, field programmable gate arrays (FPGAs), computers or the like.

Although a flow chart may describe the operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, function, procedure, subroutine, subprogram, etc. When a process corresponds to a function, its termination may correspond to a return of the function to the calling function or the main function.

As disclosed herein, the term “storage medium” or “computer readable storage medium” may represent one or more devices for storing data, including read only memory (ROM), random access memory (RAM), magnetic RAM, core memory, magnetic disk storage mediums, optical storage mediums, flash memory devices and/or other tangible machine readable mediums for storing information. The term “computer-readable medium” may include, but is not limited to, portable or fixed storage devices, optical storage devices, and various other mediums capable of storing, containing or carrying instruction(s) and/or data.

Furthermore, example embodiments may be implemented by hardware, software, firmware, middleware, microcode, hardware description languages, or any combination thereof. When implemented in software, firmware, middleware, or microcode, the program code or code segments to perform the necessary tasks may be stored in a machine or computer readable medium such as a computer readable storage medium. When implemented in software, a processor or processors will perform the necessary tasks.

A code segment may represent a procedure, function, subprogram, program, routine, subroutine, module, software package, class, or any combination of instructions, data structures or program statements. A code segment may be coupled to another code segment or a hardware circuit by passing and/or receiving information, data, arguments, parameters or memory contents. Information, arguments, parameters, data, etc. may be passed, forwarded, or transmitted via any suitable means including memory sharing, message passing, token passing, network transmission, etc.

Example embodiments may be utilized in conjunction with Radio Access Networks (RANs) such as: Universal Mobile Telecommunications System (UMTS); Global System for Mobile communications (GSM); Advance Mobile Phone Service (AMPS) system; the Narrowband AMPS system (NAMPS); the Total Access Communications System (TACS); the Personal Digital Cellular (PDC) system; the United States Digital Cellular (USDC) system; the code division multiple access (CDMA) system described in EIA/TIA IS-95; a High Rate Packet Data (HRPD) system, Worldwide Interoperability for Microwave Access (WiMAX); Ultra Mobile Broadband (UMB); and 3rd Generation Partnership Project LTE (3GPP LTE), in addition to 4G EPC.

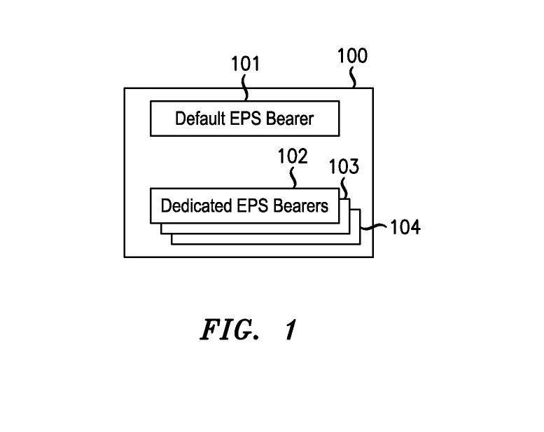

The 4G EPC network has been developed to provide a mobile device with always-on IP connectivity. The mobile device connects to a default PDN when the mobile device first registers with the network. The PDN connectivity request is piggybacked on an attach request during the mobile device registration. As part of the PDN connectivity procedure, a default EPS bearer is established and remains established throughout the lifetime of a respective PDN connection. FIG. 1 illustrates a PDN connection, according to an example embodiment. In FIG. 1, PDN connection 100 comprises a data connection, which includes a default EPS bearer context 101. Default EPS bearer context 101 remains established throughout the lifetime of the PDN connection 100. PDN connection 100 may further include one or more dedicated EPS bearer contexts 102-104. Deactivation of the default EPS bearer context 101 will result in all dedicated EPS bearer contexts 102-104 of the PDN connection 100 being deactivated, and the PDN connection 100 being disconnected as well. Since 4G EPC networks require mobile devices to maintain at least one PDN connection for IP connectivity, if PDN connection 100 is the last PDN connection between a given mobile device and the network and the PDN connection 100 is disconnected, the network will detach the given mobile device utilizing the Detach procedure, because disconnecting an only existing or last remaining PDN connection 100 would indicate the mobile device no longer requires packet data services.

Accordingly, a UE or MME requested PDN disconnection procedure normally is not used to terminate the last PDN connection. A UE typically uses the UE-initiated Detach procedure to disconnect the last PDN connection and the MME typically uses the MME-initiated Detach procedure to release the last PDN connection.

However, in 4G EPC networks, a PDN connection can be disconnected according to a variety of scenarios. First, a UE may initiate a PDN disconnection procedure. Second, a network control node, such as a Mobility Management Entity (MME), may initiate a PDN disconnection procedure. Third, another network control element, such as a PDN Gateway (PDN-GW), may initiate bearer deactivation to release all bearers belonging to the PDN.

According to applicable standards, the EPS bearer deactivation procedure can only be initiated by the MME. Thus, for the first scenario, although the request is from the UE, the PDN disconnection is realized by the MME initiating the EPS bearer context deactivation procedure by including the linked EPS bearer identity of the default bearer associated with the PDN to disconnect from. In the second and third scenarios, a PDN disconnection is achieved by the MME deactivating the default EPS bearer context of the PDN connection using the EPS bearer context deactivation procedure.

As discussed above, the last PDN may not be disconnected in the EPC network without losing IP connectivity. Accordingly, as mentioned above, the MME controls EPS bearer deactivation procedure; the EPS bearer deactivation procedure can only be initiated by the MME. The MME, based on its knowledge of the PDN connections of associated UEs, checks whether the last PDN or the default EPS bearer context of the last PDN connection is sought to be deactivated before issuing instruction to disconnect the PDN connection. Abnormal handling is provided in case a PDN disconnection request for disconnecting the last PDN or the default EPS bearer context of the last PDN connection is received. With regard to the first scenario, for example, if the UE sends a PDN DISCONNECT REQUEST message for disconnecting the last PDN on the MME, the MME sends a “PDN DISCONNECT REJECT” message to the UE with cause value indicating “last PDN disconnection not allowed”. However, in the second and third scenarios, after the MME, based on its knowledge, checks whether the last PDN or the default EPS bearer context of the last PDN connection is sought to be deactivated and in certain instances issues a PDN disconnection message to a UE, a conventional UE acts as instructed to disconnect the PDN connection. As a result, a UE may disconnect a PDN connection that the MME believes not to be the last PDN connection nor the default EPS bearer context of the last PDN connection for the UE and so instructs when, in fact, the PDN connection instructed to be disconnected is the last (i.e., only remaining) PDN connection of the UE maintained at the UE. In that case, in order to be able to once again provide packet services, the UE must reattach to the network, which may require that the mobile device be powered off and then re-powered on. Note that, in this case, the MME believes that it still has a PDN connection with the subject UE and the conventional subject UE does not provide an indication that it is in a state such that the subject UE is no longer connected to the network. In addition, there are further cases in which signaling methods for abnormal case handling have not been defined and are required. One such case involves the UE initiating an EPS bearer modification procedure to release bearer resources for the EPS bearer contexts, including the default EPS bearer context.

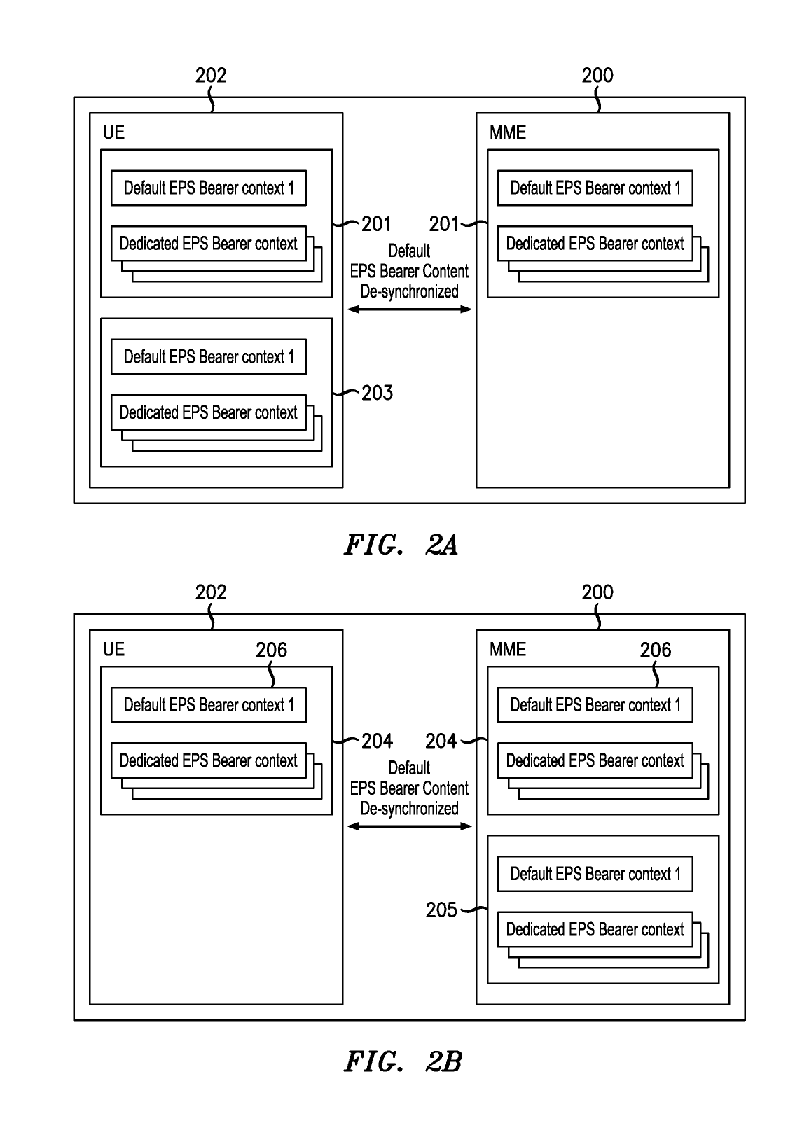

Another case requiring abnormal case handling is when the EPS bearer context on the UE and the MME are locally deactivated without peer-to-peer signaling. These cases also may result in EPS bearer context de-synchronization between the UE and the MME as shown in FIGS. 2A-B. FIGS. 2A-B illustrate de-synchronization of PDN connections between a user device and a network control node, according to an example embodiment. For example, FIG. 2A illustrates a network control element such as MME 200 and a user device such as UE 202. The MME 200 may have locally deactivated one or more PDN connections at MME 200 and thus have one remaining active connection (e.g., PDN connection 201). However, due to local deactivation at MME 200, UE 202 may not be aware of such deactivation at MME 200 and may still have more than one active PDN connections (e.g., PDN connections 201 and 203). UE 202 may be any one of, but not limited to, a mobile device, a tablet computer, a laptop, or any other device capable of establishing a communication via a 4G LTE network.

Similarly, FIG. 2B illustrates UE 202, which may have locally deactivated one or more PDN connections and thus have one remaining active connection (e.g., PDN connection 204). MME 200 may not be aware of the deactivation at UE 202 and may still have more than one active PDN connection (e.g., PDN connections 204 and 205). In both FIGS. 2A-B, the number of active PDN connections at MME 200 and UE 202 are not synchronized.

In one example embodiment, due to such de-synchronization, MME 200 may initiate a PDN deactivation by sending a Deactivate EPS bearer context request for default EPS bearer context 206 of PDN connection 204 to UE 202, since on the MME side, PDN connection 204 is not the last PDN connection (e.g., MME 200 believes that PDN connection 205 exits between MME 200 and UE 202). The abnormal case handling and signaling method for these EPS bearer context de-synchronized cases are defined herein.

In yet another case, when an error is encountered in a mandatory information element in a deactivation request message or if an unknown, erroneous, or unforeseen EPS bearer identity is received in the header of such message, a message accepting such request is returned, which is not only undesirable but may also contradict the handling for other EPS Session Management (ESM) messages during the same error condition where a rejection response is returned.

Hereinafter, signaling methods for abnormal case handling in the above described scenarios/cases will be described.

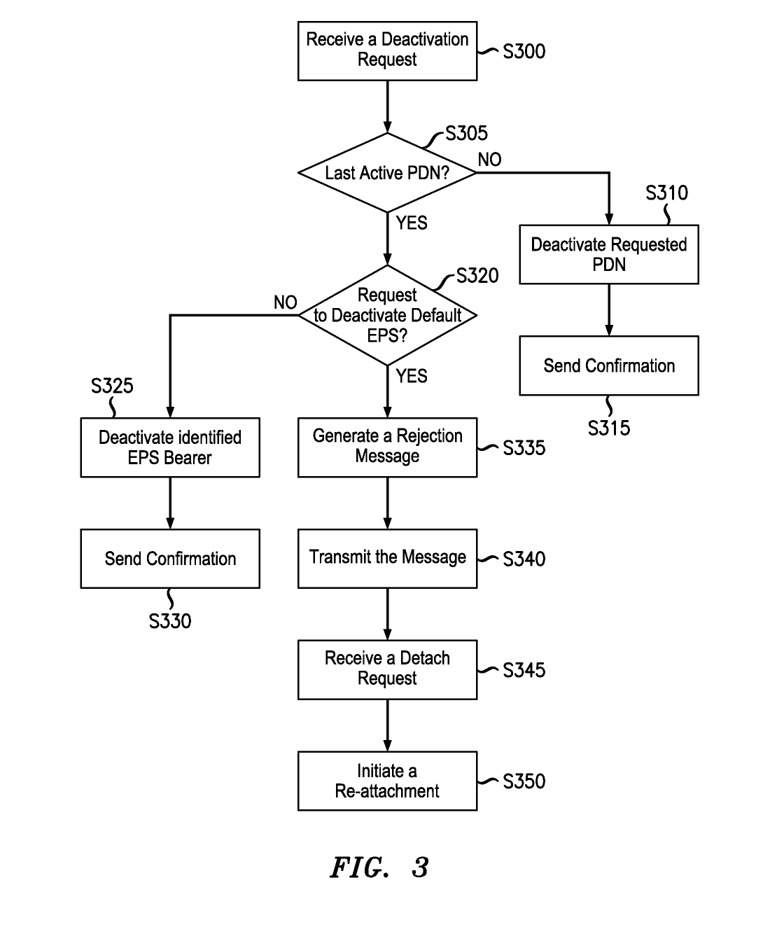

FIG. 3 describes a signaling method for handling of default PDN connections at a user device, according to an example embodiment. At S300, a user device such as UE 202, may receive a deactivation request from a network control node including, but not limited to, MME 200 or a PDN-GW for deactivating a PDN connection such as PDN connection 204 at UE 202. The deactivation request may be sent for implementing a PDN deactivation procedure. In one example embodiment, the request may be a DEACTIVATE EPS BEARER CONTEXT REQUEST message. In one example embodiment, the request includes the identity of a default EPs bearer (e.g., default EPS bearer 206) of a PDN connection (e.g., PDN connection 204) at UE 202, which may or may not be the last remaining active PDN connection at UE 202.

In one example embodiment and prior to transmitting the deactivation request, the control node (e.g., MME 200) may start a timer and enter a first state (e.g., as BEARER CONTEXT INACTIVE PENDING). The timer may be used to set a time period during which a response indicating acceptance of the deactivation request may be received.

At S305, UE 202 determines a number of active PDN connections such as PDN connection 201 at UE 202. If UE 202 determines that there is more than one active PDN connection at UE 202, at S310, UE 202 deactivates the requested PDN connection (e.g., PDN connection 201). UE 202 may deactivate the requested PDN connection by deactivating the default EPS bearer of the requested PDN connection. Thereafter, at S315, UE 202 may transmit a message confirming deactivation of the requested PDN connection to MME 200.

If, at S305, UE 202 determines that there is only one remaining active PDN connection at UE 202 (e.g., PDN connection 204 is the remaining active PDN connection at UE 202), at S320, UE 202 analyzes the received request to determine whether the EPS bearer identity indicated in the received request corresponds to the default EPS bearer (e.g., default EPS bearer 206) associated with the last remaining active PDN connection at UE 202. If the EPS bearer identity does not correspond to the default EPS bearer associated with the last remaining active PDN connection at UE 202, UE 202 deactivates the requested EPS bearer (S325) and send a confirmation back to MME 200 at S330. Throughout the application, terms such as activate/establish and deactivate/release may be used interchangeably. Activate/establish may refer to activating/establishing a PDN connection and/or an EPS bearer of a given PDN connection. Deactivate/release may refer to disconnecting/deactivating/releasing a PDN connection and/or an EPS bearer of a given PDN connection.

However, if UE 202 determines that the received request corresponds to the default bearer of the last remaining active PDN connection at UE 202, then at S335, UE 202 may generate a rejection message such as DEACTIVATE EPS BEARER CONTEXT REJECT with ESM cause set to “last PDN disconnection is not allowed”.

In one example embodiment, such rejection message is as shown in Table-1. The descriptions of what each column of Table-1 (IEI, Information Element, Type/Reference, Presence, Format and Length) represents are well-known and provided, for example, in 3GPP TS 24.301 version 8.3.0 Release 8 (sections 9.2, 9.3.2, etc., as indicated in Table-1 below).

TABLE 1

| | Information | | | | |
|---|---|---|---|---|---|
| IEI | Element | Type/Reference | Presence | Format | Length |
| | Protocol | Protocol | M | V | ½ |
| | discriminator | discriminator | | | |
| | | 9.2 | | | |
| | EPS bearer identity | EPS bearer | M | V | ½ |
| | | identity | | | |
| | | 9.3.2 | | | |
| | Procedure | Procedure | M | V | 1 |
| | transaction identity | transaction | | | |
| | | identity | | | |
| | | 9.4 | | | |
| | Deactivate EPS | Message type | M | V | 1 |
| | bearer context reject | 9.8 | | | |
| | message identity | | | | |
| | ESM cause | ESM cause | M | V | 1 |
| | | 9.9.4.4 | | | |
| 27 | Protocol | Protocol | O | TLV | 3-253 |
| | configuration | configuration | | | |
| | options | options | | | |
| | | 9.9.4.11 | | | |

In yet another example embodiment, the rejection message may be as defined in Table-2, which is a modified version of an acceptance message (e.g., DEACTIVATE EPS BEARER CONTEXT ACCEPT message). As shown in Table-2, while the ESM cause may be the same as in Table-1, the DEACTIVATE EPS BEARER CONTEXT REJECT message is changed to DEACTIVATE EPS BEARER CONTEXT ACCEPT message. The descriptions of what each column of Table-2 (IEI, Information Element, Type/Reference, Presence, Format and Length) represents are well-known and provided, for example, in 3GPP TS 24.301 version 8.3.0 Release 8 (sections 9.2, 9.3.2, etc., as indicated in Table-2 below).

TABLE 2

| | Information | | | | |
|---|---|---|---|---|---|
| IEI | Element | Type/Reference | Presence | Format | Length |
| | Protocol | Protocol | M | V | ½ |
| | discriminator | discriminator | | | |
| | | 9.2 | | | |
| | EPS bearer identity | EPS bearer | M | V | ½ |
| | | identity | | | |
| | | 9.3.2 | | | |
| | Procedure | Procedure | M | V | 1 |
| | transaction identity | transaction | | | |
| | | identity | | | |
| | | 9.4 | | | |
| | Deactivate EPS | Message type | M | V | 1 |
| | bearer context | 9.8 | | | |
| | accept message | | | | |
| | identity | | | | |
| | ESM cause | ESM cause | M | V | 1 |
| | | 9.9.4.4 | | | |
| 27 | Protocol | Protocol | O | TLV | 3-253 |
| | configuration | configuration | | | |
| | options | options | | | |
| | | 9.9.4.11 | | | |

At S340, UE 202 may transmit the generated rejection message to the control node (e.g., MME 200). In one example embodiment, upon receiving the generated rejection message, MME 200 may stop the timer and enter a second state (e.g., BEARER CONTEXT ACTIVE) and abort the EPS bearer context deactivation procedure.

Thereafter, the control node may determine from among a plurality of active packet data network (PDN) connections associated with the at least one control node, one or more active PDN connections that do not correspond to the remaining active PDN connection associated with the at least one user device and subsequently delete the non-corresponding one or more active PDN connections. As a result, the network control node (e.g., MME 200) may initiate and transmit a detach procedure using detach type “re-attach required”.

Accordingly, the UE may receive the detach request at optional step S345. The detach request may be a normal network initiated detach procedure to be used for various purposes to detach/reattach the UE. The detach request may be carried out by specifying a Detach Type, in an Information Element, shown in the above Table-1 and/or Table-2, of a message, to be performed at the UE side. The Detach Type may be, for example, re-attach required or re-attach not required.

Upon receiving the detach request, if the detach type is re-attach, the UE optionally, at S350, may initiate an additional attachment procedure for PDN connections for which the detach request was received. According to the attachment procedure, EPS bearer contexts between the UE 202 and MME 200 may be synchronized.

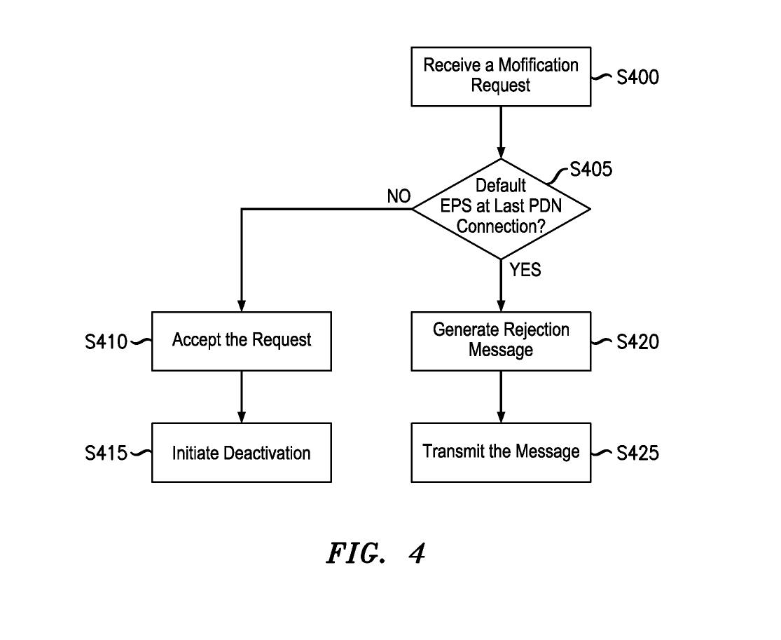

FIG. 4 describes a signaling method for handling of default PDN connections, according to an example embodiment. At S400, the control node (e.g., MME 200), may receive a bearer resource modification request (e.g., BEARER RESOURCE MODIFICATION REQUEST) from UE 202. In one example embodiment, the request may include the operation code set to “Delete Packet filters from existing Traffic Flow Template (TFT)” to indicate release of all or specific bearer resources for a given PDN connection (e.g., default EPS bearer or dedicated EPS bearer of one or more PDN connections at the control node). UE 202, prior to transmitting the modification request may start a timer and enter a procedure transaction pending/bearer context active state. The timer may be used to set a time period during which a response indicating acceptance of the request is expected to be received. In one example embodiment, if no response is received within the set time period, then UE 202 may abort the modification procedure. The time period may be set by a user/system operator at the time of configuring the system, based on empirical studies, etc.

At S405, the control node (e.g., MME 200) may determine whether the request is for release of a default bearer context of the last remaining active PDN connection at the control node. If the request is not for release of a default bearer context of the last remaining active PDN connection, then at S410, MME 200 accepts the modification request and at S415 initiates the EPS bearer context deactivation procedure.

However, if the control node (e.g., MME 200) determines, at S405, that the release request is for the default EPS bearer context for the last remaining active PDN at the control node, then the control node may generate a rejection message (e.g., a BEARER RESOURCE MODIFICATION REJECT message with ESM cause set to “last PDN disconnection not allowed”) (S420). In one example embodiment, the only remaining active PDN connection at MME 200 is the PDN connection 201, as shown in FIG. 2A. Accordingly, MME 200 may determine that the release request is for the default EPS bearer context if the modification request includes the identity of the default bearer context of PDN connection 201. In one example embodiment, the identity may be included as PDN201_ctx1 in the request at MME 200. The rejection message may be generated in a similar manner as described above with respect to Table-1/Table-2 with the proper modification to the information element columns (e.g., message type and ESM cause). At S425, the control node may transmit the generated rejection message to UE 202.

Upon receiving the rejection message, UE 202 may stop the timer and enter a “PROCEDURE TRANSACTION INACTIVE” state, according to which the default EPS bearer context of PDN connection 102 remains active.

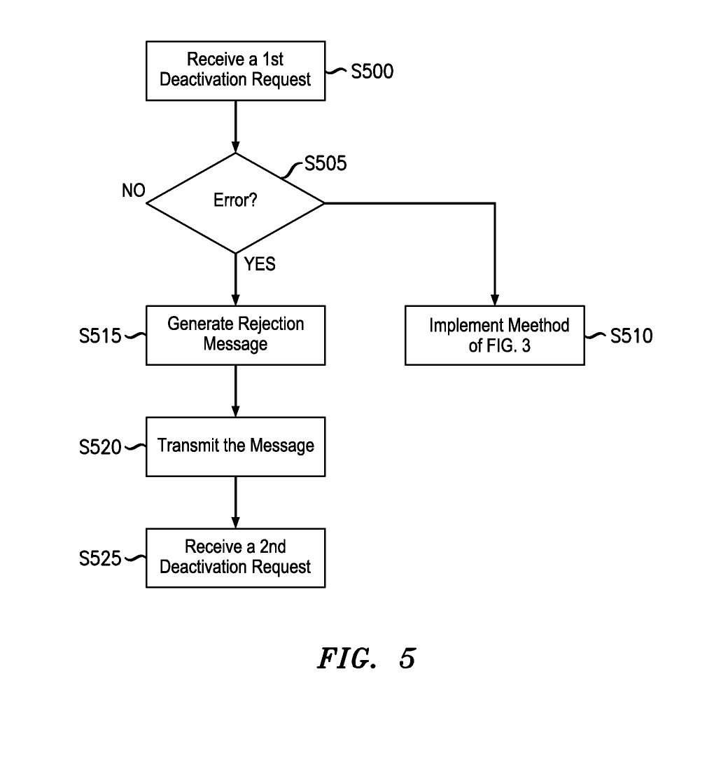

FIG. 5 illustrates a signaling method for handling of errors in deactivation requests received at a user device, according to an example embodiment. At S500, a UE, such as UE 202, may receive a first deactivation request (e.g., DEACTIVATE EPS BEARER CONTEXT REQUEST″ message) from a network control node (e.g., MME 200). Prior to transmitting the first deactivation request to UE 202, the network control node may start a timer and enter a BEARER CONTEXT INACTIVE PENDING state. The timer may be used to set a time period during which a response indicating acceptance of the first deactivation request may be received. Thereafter, the network control node may transmit the deactivation request to UE 202.

At S505, UE 202 may analyze the received first request. In one example embodiment, the analyzing includes decoding the received first request to determine whether the received first request contains an error. In one example embodiment, UE 202 determines whether the first request contains an error(s) related to the message's mandatory Information Element, as reflected above in Table-1/Table-2. The mandatory Information Elements for DEACTIVATE EPS BEARER CONTEXT REQUEST may include any one of, but not limited to, a Protocol discriminator, an EPS bearer identity, a procedure transaction identity, a Deactivate EPS bearer context request message identity, an ESM cause, etc. If UE 202 determines that no error exists, at S510, UE 202 may implement the signaling method described above with respect to FIG. 3.

However, if mandatory Information Element(s) are not formatted properly, UE 202 may determine that the first activation request contains error(s). If UE 202 determines at S505 that the first deactivation request contains error(s) related to message's mandatory Information Element, at S515, UE 202 may generate a rejection message, such as a DEACTIVATE EPS BEARER CONTEXT REJECT message with the ESM cause set to one of “Invalid mandatory information” or “Invalid EPS bearer identity”. In one example embodiment, “Invalid mandatory information” error may be related to an encoding and/or formatting of the mandatory Information Elements. “Invalid EPS bearer identity” may be related to a value of the “EPS bearer identity” Information Element. For example, if an EPS bearer identity IE is formatted correctly, but the UE is not able to identify any EPS context with such identity, then a rejection message with the ESM cause set to “Invalid EPS bearer identity” may be generated.

At S520, UE 202 may transmit the generated rejection message to MME 200. Upon receiving the generated rejection message, MME 200 may stop the timer and enter a BEARER CONTEXT ACTIVE state. Thereafter, MME 200 may either abort the EPS bearer context deactivation procedure or re-initiate the procedure with corrected information based on which UE 202 generated the rejection message.

In one example embodiment, at S525, UE 202 may receive a second deactivation request from MME 200. The second request may be generated by MME 200 with the mandatory Information Element being corrected based on the rejection message received at MME 200.

While example embodiments have been described with reference to LTE based communication systems, developing similar methods and systems compatible for other types of communication systems (e.g., a GSM communication system) are intended to be within the scope of the present subject disclosure.

Variations of the example embodiments are not to be regarded as a departure from the spirit and scope of the example embodiments, and all such variations as would be apparent to one skilled in the art are intended to be included within the scope of this disclosure.

What is claimed:

1. A method comprising:
receiving, by at least one user device, a request to deactivate at least one packet data network (PDN) connection between the at least one user device and at least one control node of a communication system;
determining, by the at least one user device, whether the at least one PDN connection is the only remaining PDN connection associated with the at least one user device; and
generating, by the at least one user device, a message based on the determining.

2. The method of claim 1, wherein the at least one control node is at least one of a mobile management entity (MME) generating the request and a packet data network gateway (PDN-GW).

3. The method of claim 1, wherein the at least one user device is a 4G Long Term Evolution (LTE) based device.

4. The method of claim 1, wherein the determining further comprises:
analyzing the received request to determine a specific bearer context of the at least one PDN connection indicated in the request; and
determining whether the specific bearer context corresponds to a default bearer context of the only remaining PDN connection at the at least one user device.

5. The method of claim 4, wherein the generating generates a message indicating a denial of the request if the determining determines that the specific bearer context corresponds to the default bearer context of the only remaining PDN connection at the at least one user device.

6. The method of claim 1, further comprising:
transmitting the generated message to the at least one control node.

7. The method of claim 1, wherein the at least one control node aborts the deactivation if the generated message is not received at the at least one control node within a time period set by the at least one control node.

8. The method of claim 6, further comprising:
receiving a detach request from the at least one control node;
initiating a re-attachment procedure based on the received detach request; and
transmitting a confirmation message regarding the re-attachment procedure to the at least one control node.

9. A method comprising:
receiving, by at least on user device, a first request to deactivate at least one packet data network (PDN) connection between the at least one user device and at least one control node of a communication system;
analyzing, by the at least on user device, the received first request;
generating, by the at least one user device, at least one of an acceptance message and a rejection message based on the analyzing; and
transmitting, by the at least one user device, the generated message to the at least one control node.

10. The method of claim 9, wherein the at least one control node is at least one of a mobile management entity (MME) generating the first request and a packet data network gateway (PDN-GW) generating the first request, and
the at least one user device is a 4G Long Term Evolution (LTE) based device.

11. The method of claim 9, wherein the analyzing comprises:
decoding the received first request; and
determining whether the first request contains an error corresponding to a mandatory information element of the first request.

12. The method of claim 11, wherein the generating generates a message indicating a rejection of the request if the determining determines that the information element of the first request contains the error.

13. The method of claim 12, further comprising:
transmitting the message to the MME, wherein the message includes at least one of an invalid mandatory information message and an invalid evolved packet service (EPS) bearer identity message.

14. The method of claim 13, further comprising:
receiving a second request with a corrected mandatory information element, to deactivate the at least one PDN connection, the second request being generated by the at least one control node upon receiving the invalid mandatory information message.

15. The method of claim 13, wherein the MME aborts the deactivation upon receiving the invalid EPS bearer identity message.

16. A method comprising:
receiving, at a control node of a communication system, a resource modification request from at least one user device of the communication system;
determining whether the resource modification request is associated with the only remaining packet data network (PDN) connection at the control node; and
generating a response based on the determining.

17. The method of claim 16, wherein upon determining that the resource modification request is associated with the only remaining PDN connection at the control node, the determining comprises:
analyzing the resource modification request to determine whether a default bearer context of the only remaining PDN connection is to be modified.

18. The method of claim 16, wherein the generating generates a response indicating a denial of the resource modification request if the analyzing determines that the default bearer context of the only remaining PDN connection is to be modified.

19. The method of claim 18, further comprising:
transmitting the response to the at least one user device.

20. The method of claim 16, wherein the control node aborts the deactivation if the response is not received at the control node within a time period set by the control node.

21. A user device comprising:
a processor configured to,
receive a request to deactivate at least one packet data network (PDN) connection between the user device and at least one control node of a communication system,
determine whether the at least one PDN connection is the only remaining PDN connection associated with the user device, and
generate a message based on the determination.

22. The user device of claim 21, wherein the processor is configured to determine whether the at least one PDN connection is the only remaining PDN connection associated with user device by,
analyzing the received request to determine a specific bearer context of the at least one PDN connection indicated in the request; and
determining whether the specific bearer context corresponds to a default bearer context of the only remaining PDN connection at the user device.

23. The user device of claim 22, wherein the generated message indicates a denial of the request if the processor determines that the specific bearer context corresponds to the default bearer context of the only remaining PDN connection at the user device.

24. The user device of claim 21, wherein the processor is further configured to transmit the generated message to the at least one control node.

25. The user device of claim 21, wherein the user device is a 4G Long Term Evolution (LTE) based device.
